(19) United States
(12) Patent Application Publication
(10) Pub. No.: US 2006/0277172 A1
(43) Pub. Date: Dec. 7, 2006

(54) System and method for managing tasks

(76) Inventor: Brian M. Crow, Tracy, CA (US)

Correspondence Address: COURTNEY STANIFORD & GREGORY LLP, P.O. BOX 9686, SAN JOSE, CA, 95157, US

(21) Appl. No.: 11/432,910

(22) Filed: May 12, 2006

Related U.S. Application Data
(60) Provisional application No. 60/680,614, filed on May 13, 2005.

(51) Int. Cl. G06F 17/30

(52) U.S. Cl. 707/4

(57) ABSTRACT

Systems and methods are provided for resolving outstanding issues or items associated with one or more tasks or projects. In various embodiments, data flows to a management application and an associated database and then back to an originating device. In various embodiments, the systems and methods use wireless devices and associated infrastructure to address problems and/or concerns in real-time. The systems and methods provide a tailored solution for individuals and companies utilizing lists and the like to communicate, schedule, and/or maintain information with other entities, such as supply chain suppliers, sub-contractors, etc. Information may be centrally stored and maintained in real-time with immediate access available using a processor-based device via a network.

### RELATED APPLICATIONS

This application claims priority to U.S. Provisional Patent Application No. 60/680,614, filed May 13, 2005.

### BACKGROUND

In today's digital society, individuals and companies are finding a need to readily consolidate, access, and disseminate pertinent business data. This can be a cumbersome task due to the large amounts of unorganized data typically associated with individuals and companies. It has also been recognized that many companies are once again going back to their core competencies, while outsourcing non-core competencies. As many have experience, outsourcing has led to additional communication and integration issues. For example, many companies would like to seamlessly integrate with other entities, such as suppliers, sub-contractors, etc., preferably without delay and/or in real-time. Consequently, in many instances, marketplace success requires trust, dependence, and reliance on numerous suppliers and/or sub-contractors to provide quality services and/or products to customers. Without marketplace success, a company has a difficult time establishing and maintaining its goodwill.

Take for example the intertwined relationships between a home builder or developer and its sub-contractors and/or suppliers when building a new home. Currently, there is a lack of robust communication between the home builder and their sub-contractors. For example, telephones and two-way radios are commonly used for informal communication between the home builder and the sub-contractors. However, written instruments, such as punch-lists and the like, are commonly used to formally track problems and/or issues that arise between the home builder and the sub-contractors. If a home builder sees a problem, the home builder writes-up the problem and faxes the write-up to the one or more sub-contractors. These communication techniques are standard ways to communicate across many industries; however, in many instances these techniques are inefficient, cumbersome, unreliable, and inadequate. Currently, in situations like these and others, there lacks a robust mechanism for timely communication of issues/problems, issue/problem management, time management, and real-time access between two or more parties to resolve issues/problems.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTION OF THE DRAWINGS

FIG. 1 is a block diagram depicting a management system, under an embodiment.

FIG. 2 is a flow diagram for using a management system, under an embodiment.

FIG. 3 is a screen shot of a login page of a user interface of a management application, under an embodiment.

FIG. 4 is a screen shot of a home page of a user interface of a management application, under an embodiment.

FIG. 5 is a screen shot of a review page of a user interface of a management application, under an embodiment.

FIG. 6 is a screen shot of a create list page of a user interface of a management application, under an embodiment.

FIG. 7 is a screen shot of a supplier page of a user interface of a management application, under an embodiment.

FIG. 8 is a screen shot of a development page of a user interface of a management application, under an embodiment.

FIG. 9 is a screen shot of a search page of a user interface of a management application, under an embodiment.

FIG. 10 is a screen shot of a Spanish translation page of a user interface of a management application, under an embodiment.

FIG. 11 is a block diagram depicting the interrelation between various tables and libraries of a management application, under an embodiment.

### DETAILED DESCRIPTION

Systems and methods are provided for resolving outstanding issues or items associated with one or more tasks. In various embodiments, data flows to a management application and an associated database and then back to an originating device. For example, if a user is using a smart device, the user accesses a management application and associated database for entry of any outstanding or open items associated with a task or project, which are then saved to the database. In various embodiments, the systems and methods use wireless devices and associated infrastructure to address problems and/or concerns in real-time.

Embodiments of the systems and methods provide a tailored solution for individuals and companies utilizing lists and the like to communicate, schedule, and/or maintain information with other entities, such as supply chain suppliers, sub-contractors, etc. Information may be centrally stored and maintained in real-time with immediate access available using a processor-based device, such as desktop/laptop systems, handheld, and other smart devices, via a network. The systems and methods provide real-time access to the information over the network, providing virtualized services, and interaction with a user device. In certain embodiments, the systems and methods use a web-enabled or similar application, which may be accessed using a user device without the need for additional applications to be loaded by the users/customers on the user device. Thus, a user and/or customer has more time to concentrate on core issues, since there is no required application on the user device for which the customer has to support and maintain.

In an embodiment, the systems and methods use a web-based application or interface consisting of a structured query language (SQL) server database, SQL server code, and hypertext markup language (HTML) code. Other coding techniques may also be used. The systems and methods provide an application, including a database, for business to business (B2B), individual to business, business to individual, and individual to individual communications. For example, the systems and methods enable businesses to communicate certain defined parameters between one another in real-time without having to download and maintain complex applications. The systems and methods provide a tool to manage information, such as to-do lists for example, centrally and via processor-based devices, including handheld and portable devices. The systems and methods enable one entity, in real-time, to communicate to another entity that an issue or item needs to be addressed and/or remedied. The issue or item can then be resolved and communicated to the originating entity that the issue or item is resolved.

In the following description, numerous specific details are introduced to provide a thorough understanding of, and enabling description for, embodiments of the invention. One skilled in the relevant art, however, will recognize that the invention can be practiced without one or more of the specific details, or with other components, systems, etc. In other instances, well-known structures or operations are not shown, or are not described in detail, to avoid obscuring aspects of the invention.

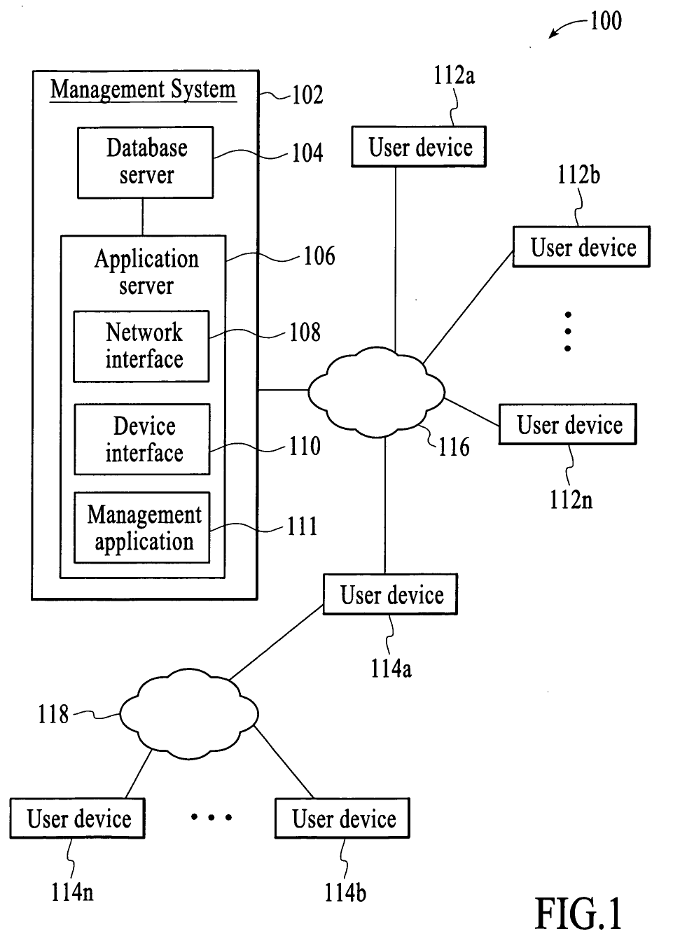

FIG. 1 is a block diagram depicting a system 100 for managing provided under an embodiment. The system 100 includes a management system 102 which allows one or more users to manage a plurality of tasks and any associated issues or open items, as described in detail below. For example, the management system 102 provides a means for a user to manage to-do lists and the like as part of one or more projects. As shown in FIG. 1, the management system 102 includes a database server 104 for maintaining data of one or more databases. The management system 102 also includes an application server 106. The database server 104 and application server 106 may be co-located or located at different locations. According to an embodiment, the application server 106 includes a network interface 108, a device interface 110, and a management application 111, but is not so limited. In another embodiment the database server 104 and application server 106 may comprise a single server that maintains the database and application components. In an embodiment, the management system 102 is configured as an application service provider.

The database server 104 and any associated database may be implemented using any standard SQL database. For example, MYSQL, SQLServer, Oracle, DB2 or any other database known or not yet known may be used. In an embodiment, the code of the management application 111 is coded using a native language of a selected database. The network or web interface 108 may be constructed utilizing any industry standard network or web development software or combination thereof that has the ability to connect to a database. For example, web development software, such as PHP, ASP.net, ASP, Coldfusion, FrontPage, etc. may be used to construct and implement the network interface 108. The web page(s) may be designed to be flexible to service various business and other disciplines who utilize lists, schedules, and related information as part of a business model.

With continuing reference to FIG. 1, the system 100 includes a number of user devices 112a-112n and 114a-114n. However, the system 100 is not limited to any specific number or type of user devices and, in certain embodiments, one user device is adequate to interact with the management system 102. Such user devices may include, but are not limited to, processor-based devices such as personal computers, portable computing devices, smart devices, cellular telephones, portable communication devices, and personal digital assistants (PDAs). The user devices 112a-112n and 114a-114n are coupled to the management system 102 via one or more networks 116 and 118. The user devices 112a-112n and 114a-114n may be coupled to the management system 102 and the one or more networks 116 and 118 via wireless, wired, or combination thereof. The networks 116 and 118 include, but are not limited to, local area networks (LANs), metropolitan area networks (MANs), wide area networks (WANs), proprietary networks, interoffice or backend networks, the Internet (or world-wide web), and other networks.

A user, using a user device, can interact with the management system 102 to manage one or more tasks, projects, and other data or information. The device interface 110 may be implemented based on the type or types of user devices which are to interact with the management system 102. Depending on the user device, an HTML or web design software variation that resides on the application server 106 may be created to communicate directly with a database and the user device, in similar fashion to a web-based interface. For example, certain devices use native HTML for browsing, while other devices use other browser functionality. The user devices are not limited to any specific browser capability, but instead depend on the specific device and application.

In an embodiment, a user device is web-enabled and does not require a specialized application, other than a browser or similar interface, to interact with the management system 102. In an embodiment, a user device includes a browser and uses a uniform resource locator (URL), or other means of communication, to communicate with the management system 102 and management application 111 to interact with a database or databases maintained on the database server 104. The management system 102 is configured to recognize which device is being used to log-in. That is, the management system 102 recognizes a particular communication by way of a protocol or other identifying indicia communicated by a user device. After recognizing a particular device or devices, the management system 102 is configured to communicate (push or pull) a user interface, such as a web page, to the device or devices. For example, if a user is using a PDA to communicate with the management system 102, the management system 102 recognizes that the communication is from a PDA, and is able to communicate a user interface, such as web page, to the PDA for further interaction.

In an embodiment, the management application 111 operates in part using database constructs, such as tables, queries, etc. The management application 111 can interact with the database server 104 to push and pull data from one or more database stored thereon. In an embodiment, the management application 111 uses a number of tables and libraries when interacting with a user using a user device to interact with the management system 102 and management application 111. Information can be stored and accessed using the tables and/or libraries when the user interacts with the management system 102 and application 111.

In one embodiment, the management application 111 includes a number of tables to create, access, monitor, store, differentiate, and organize user data, but is not so limited. The following list of tables provides a sample of the interactive tables for a management system tailored to the building or development industry. The list of tables is not meant to be all inclusive and other tables can be added. The tables below are configured to correspond to a particular aspect of a build or development process as shown below.

TBL_LOT
TBL_INTERIOR_FLOOR_PLAN
TBL_USER
TBL_SECURITY
TBL_FORM
TBL_COMPANY
TBL_PUNCH_LIST
TBL_STAGE
TBL_PROBLEM_LIST
TBL_BUSINESS_TYPE
TBL_AREA
TBL_QUALITY
TBL_SUPPLIER
TBL_ADDRESS
TBL_DIVISION
TBL_DEVELOPMENT
TBL_STAGE
TBL_SCHEDULE
TBL_INVOICE
TBL_AR
TBL_PAYMENTS
TBL_CREDITS_DEBITS

The management system 102 is configured to operate in real-time. That is, as soon as a user enters an item and saves it, that item is available to the receiving entity or entity of concern. At the end of the day a batch process can run and automatically send out e-mail notifications to each entity that new items are available for review. In addition, each entity can receive an automated tailored e-mail that items are available for review. In cases where the receiving entity does not have e-mail, the sending entity can print the item and fax to the receiving entity.

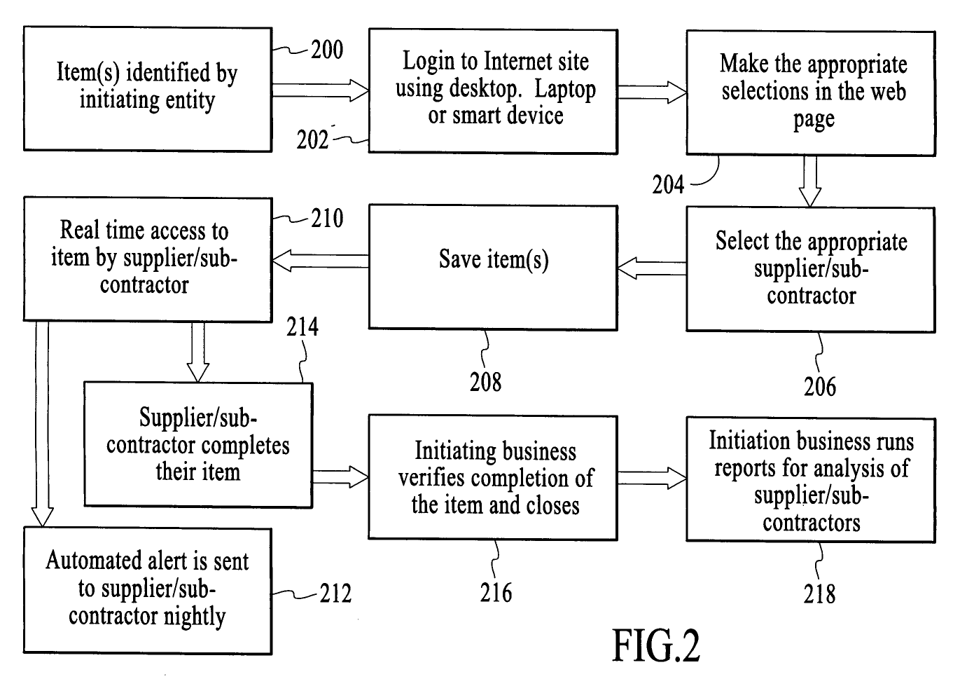

FIG. 2 is a flow diagram for using a management system, under an embodiment. At 200, an item is identified by an initiating entity, such as a business. For example, the identified item may be a defect or other issue identified as part of the building of a home. After the item or items are identified, a user using a user device, such as a desktop, laptop, or smart device for example, logs in to a network, such as an internet site for example, at 202. In an embodiment, the user login is a smart login. In an embodiment, the management system uses the smart login information to recognize the type of device that a user is accessing the system with, while also determining what information the user can access. For example, an Executive may have access to many Developments when logged in.

The management system 102 is configured to determine which product or information that a specific user is authorized to use, based in part on a user's login credentials, such as a username, password and/or company code or other representative information. The company code validation operates as an additional level of security. The login information provides a secure gateway for accessing the management system 102. Furthermore, custom menu items can be derived based in part on the login information, which further operates to narrow down a list of relevant values for various menu items. The management system 102 can also be configured with extra security measures. For example, an https or other protocol can be enabled for greater security.

At 204, after logging in, the user interacts with a web page or similar interface, making appropriate selections according to the item or issue of concern. At 206, the user selects an entity, such as a supplier or sub-contractor for example, to which the item or issue concerns. At 208, the user can save the item or issue in the database or databases. At 210, the supplier or sub-contractor is now able to login to the management system and access the identified item or issue in real-time. Alternatively, or in combination with block 210, an automated alert, such as an e-mail, text message, tactile, auditory or other sensory alert, may be sent at 212 to the supplier or sub-contractor at a desired time, such as nightly or after-hours for example. An alert may also be communicates which informs the supplier or sub-contractor that a new issue/item has been posted. At 214, after interacting with the management system and reviewing the item or issue, the supplier or sub-contractor remedies the item or issue, thereby completing the item or issue. At 216, the initiating entity manages the item/issue and verifies its completeness. If the item or issue is complete, the initiating entity closes the item or issue. At 218, the initiating entity has the option to run one or more reports to analyze the performance of various suppliers or sub-contractors.

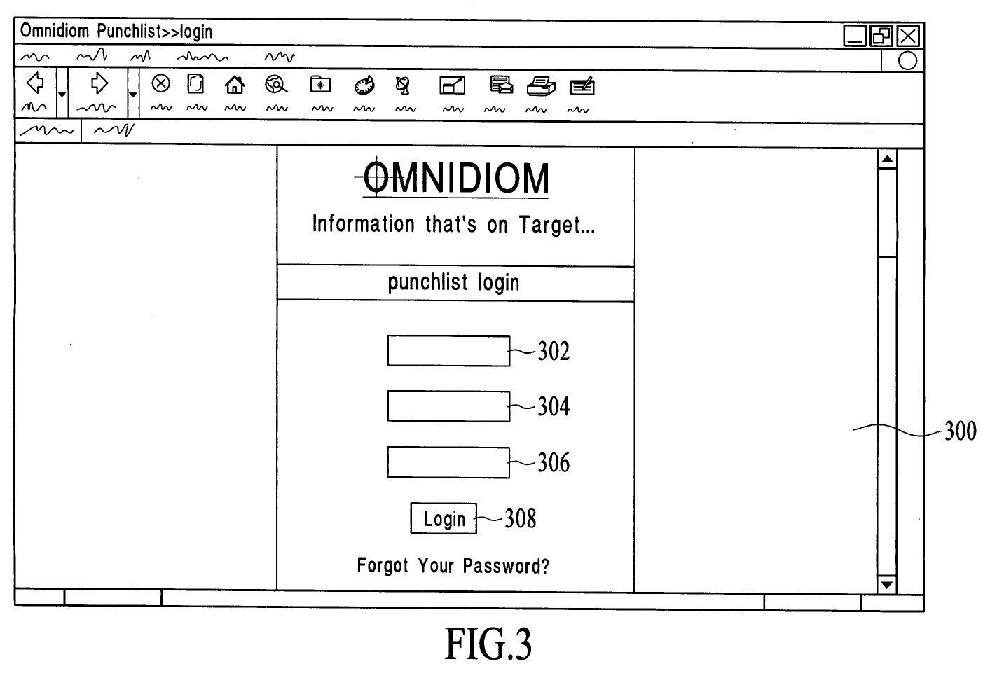

FIG. 3 is a screen shot of a login page 300 of a user interface of a management application, under an embodiment. The login page 300 provides an interface which allows a user to login to the management application. As shown in FIG. 3, the login page 300 includes a username field 302 for inputting a username, a password field 304 for inputting a password associated with the username, and a company code filed 306 for inputting a company code associated with the matter. Once a user has entered a proper username, password, and company code, the user clicks on the login button 308 to login to the management application. As described below, under an embodiment, the user login credentials determine a type of user interface presented by the management system 102 and the accessible information available to the user.

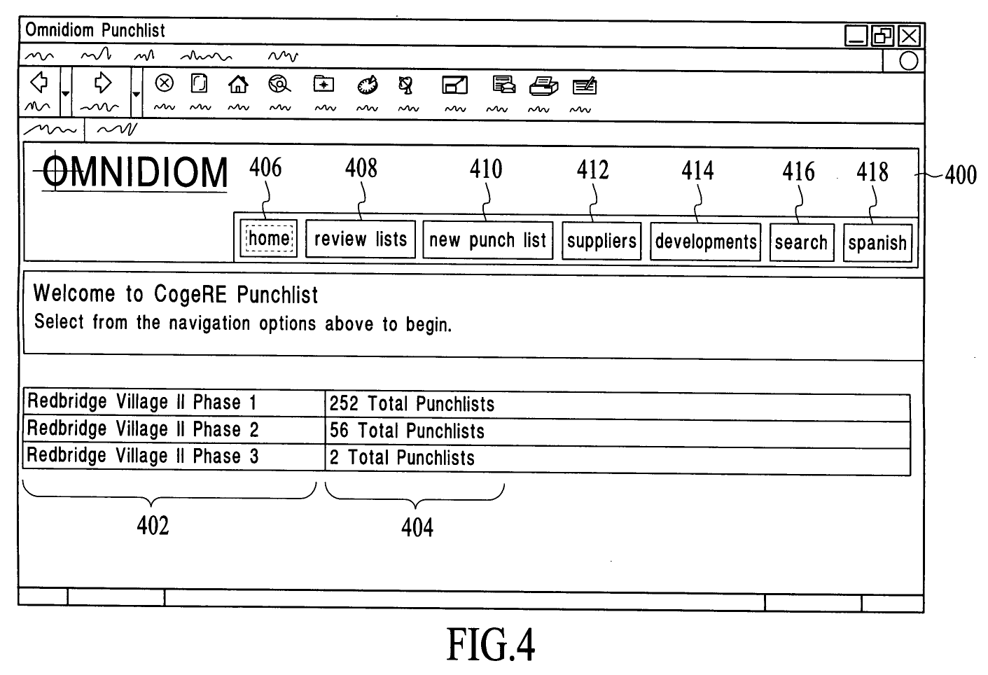

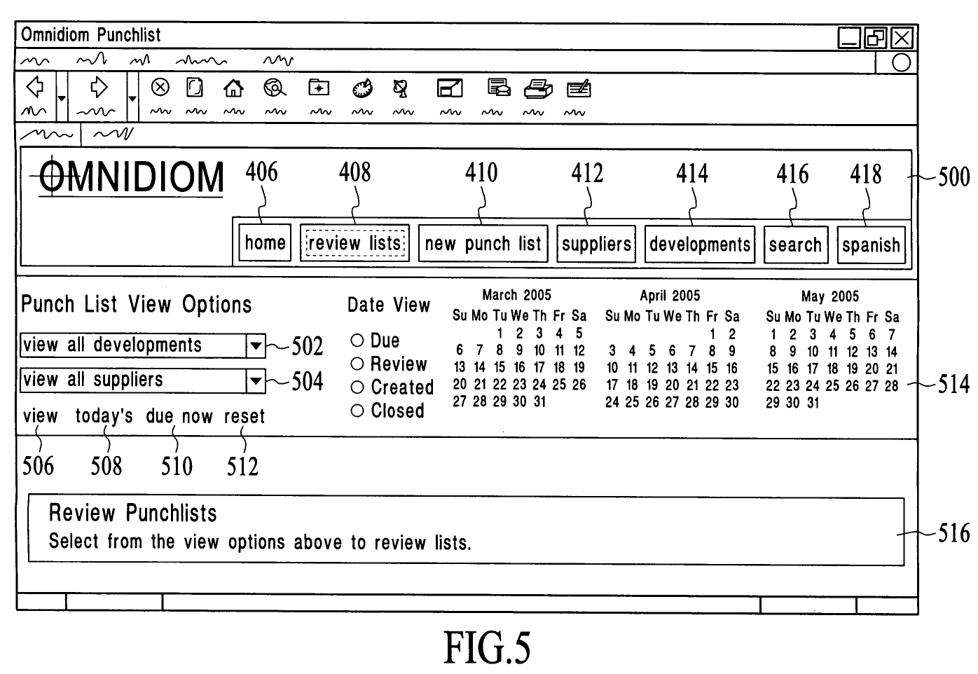

FIG. 4 is a screen shot of a home page 400 of a user interface of a management application, under an embodiment. The home page 400 provides an interface for a user to navigate various features of the management application. Once a user has logged in to the management application, the home page 400 is presented for user interaction. FIG. 4 is an example of various developments 402 with their associated punch lists 404. The home page 400 includes a number of buttons that a user can use to interact with the management application. As shown in FIG. 4, the management application includes a home button 406, a review lists button 408, a new punch list button 410, a suppliers button 412, a developments button 414, a search button 416, and a Spanish translation button 418.

FIG. 5 is a screen shot of a punch list review page 500 of a user interface of a management application, under an embodiment. The punch list review page allows a user to interact with various punch lists. The user may access the punch list review page 500 by clicking on the review lists button 408. As shown in FIG. 5, the punch list review page 500 includes a view all developments drop-down menu 502, a view all suppliers drop-down menu 504, a view button 506, a today's button 508, a due now button 510, and a reset button 512. The punch list review page 500 also includes a calendar window 514 and a review window 516.

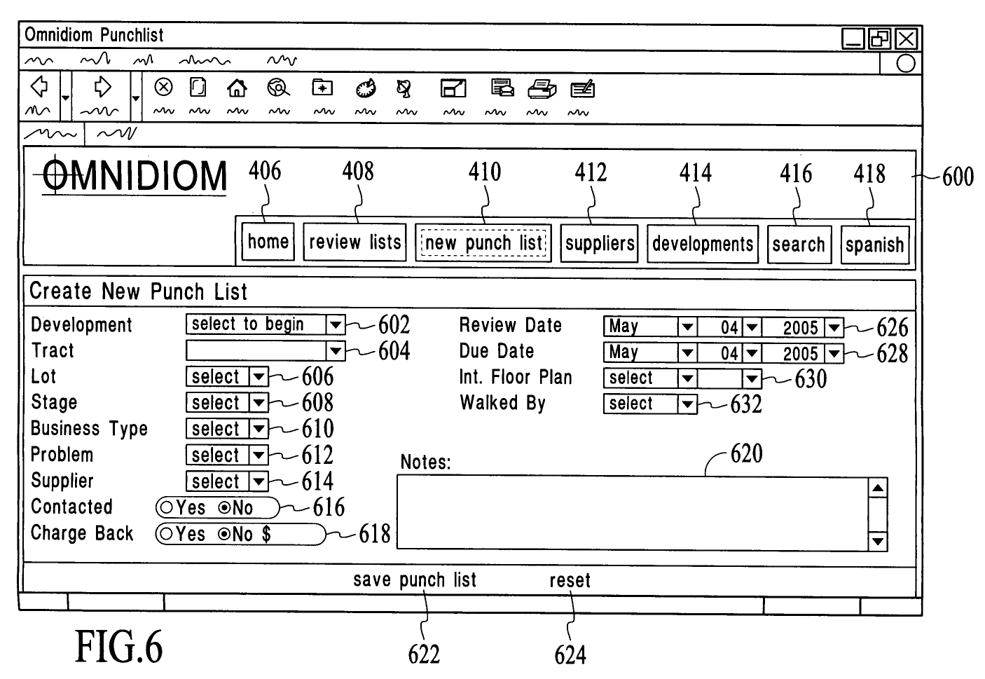

FIG. 6 is a screen shot of a create list page 600 of a user interface of a management application, under an embodiment. The create list page 600 provides an interface which allows a user to create a new punch list after a user has clicked on the new punch list button 410. As shown in FIG. 6, the create list page 600 includes a development drop down menu 602, a tract dialog 604, a lot drop down menu 606, a stage drop down menu 608, a business type down menu 610, a problem drop down menu 612, a supplier drop down menu 614, contacted radio buttons 616, charge back radio buttons and dialog box 618, notes dialog box 620, a save button 622, a reset button 624, review date drop down menus 626, due date drop down menus 628, an interior floor plan drop down menu 630, and a walked by drop down menu 632. The various drop down menus, buttons, and other dialog boxes enable a user to define a new punch list according to desired criteria.

In an embodiment, described as follows, the development drop down menu 602 corresponds to a development in which an activity is occurring in. The tract dialog 604 can then be automatically filled based on the definition of the development. The lot drop down menu 606 can be based on the development and lot numbers become available in the drop down box. The stage drop down menu 608 can identify at what stage the business product is at, and can be based on input from a customer, which is flexible. The business type down menu 610 includes various business types which can be associated with a stage. Again, this can be based on input from a customer and is flexible.

According to this embodiment, the problem drop down menu 612 can be a list that is generated by a customer to identify areas within a stage that a supplier will be required to complete. The supplier drop down menu 614 lists suppliers that are associated with the business type. There can be multiple suppliers for a business type, and can be based on the problem list. The review date drop down menus 626 can be automatically defaulted to the current date and/or can be changed. The due date drop down menus 628 can be automatically defaulted to the current date and/or can be changed. The interior floor plan drop down menu 630 can be a list that can be generated by a customer which helps further define the area of concern. The walked by drop down menu 632 can be a list of people who have responsibility within a selected development. The notes dialog box 620 can be a free form text field for making specific notes.

Additional menus and dialog boxes may be included. For example, a milestone drop down menu can define a milestone that a particular lot is at. Utilizing a development table and corresponding lot table, a certain lot can have a stage, milestone, and/or an action list with corresponding suppliers. Using the construction industry as an example, a certain Lot might be at a framing stage, with a milestone of First Floor framing and an action list of pre-electrical, pre-plumbing, and wall framing with each having different suppliers. Action lists can be triggered when a lot moves from one stage to another. Using the construction industry as an example; when the frame inspection (Action List item in Stage Framing) is approved then the stage will change from framing to drywall and new milestones will be automatically generated with the corresponding action lists and requisite suppliers. The action lists can contain due dates along with the supplier(s) responsible and whether an action has been completed.

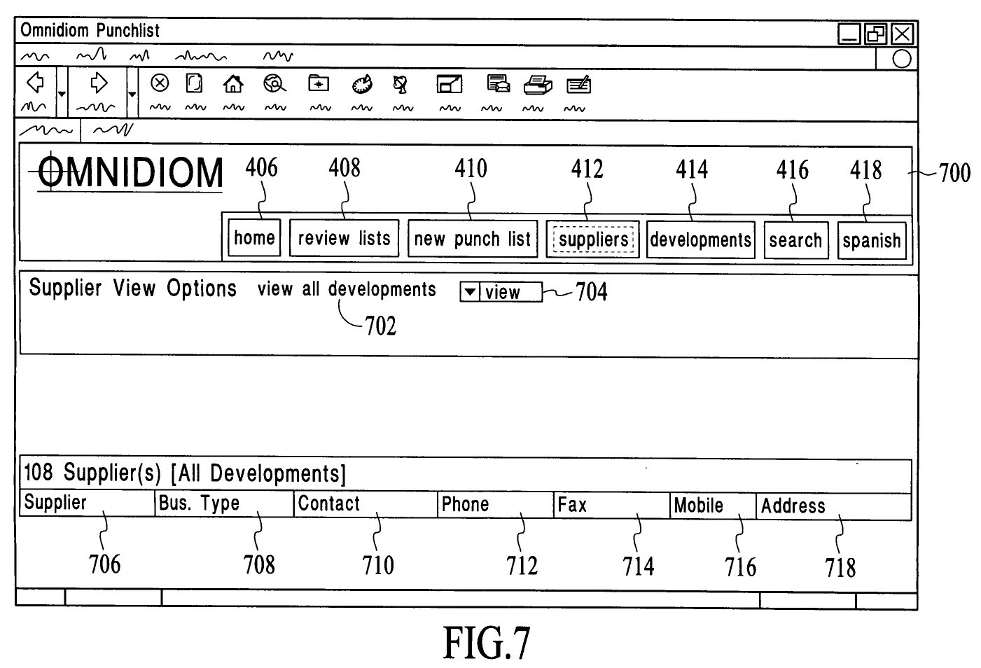

FIG. 7 is a screen shot of a supplier page 700 of a user interface of a management application, under an embodiment. The supplier page 700 provides an interface which allows a user to review supplier information after a user has clicked on the suppliers button 412. As shown in FIG. 7, the supplier page 700 includes a supplier view drop down menu 702 and associated view button 704. Various fields provide information associated with various suppliers. The supplier page 700 includes a supplier field 706 for identifying a supplier, a business type field 708 for identifying the type of business associated with the supplier, a contact field 710 for identifying a point of contact for the supplier, a phone number field 712 for identifying a phone number of the supplier, a fax number field 714 for identifying a fax number of the supplier, a mobile number field 716 for identifying a mobile number of the supplier, and an address field 718 for identifying an address of the supplier.

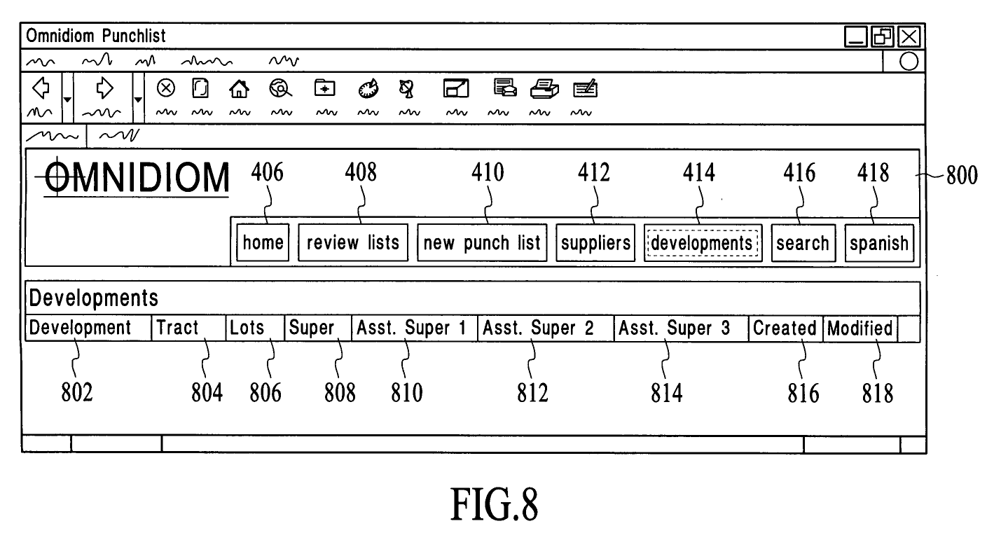

FIG. 8 is a screen shot of a development page 800 of a user interface of a management application, under an embodiment. The development page 800 provides an interface which allows a user to review development information after a user has clicked on the developments button 414. As shown in FIG. 8, various fields provide information associated with various developments. The development page 800 includes a development field 802 for identifying a development, a tract field 804 for identifying a development tract, a lot field 806 for identifying a lot in a development, a supervisor field 808 for identifying a supervisor associated with a development, a first assistant supervisor field 810 for identifying a first assistant supervisor associated with a development, a second assistant supervisor field 812 for identifying a second assistant supervisor associated with a development, a third assistant supervisor field 814 for identifying a third assistant supervisor associated with a development, a created field 816 for identifying the creation date of a development, and a modified field 818 for identifying a modified date of a development.

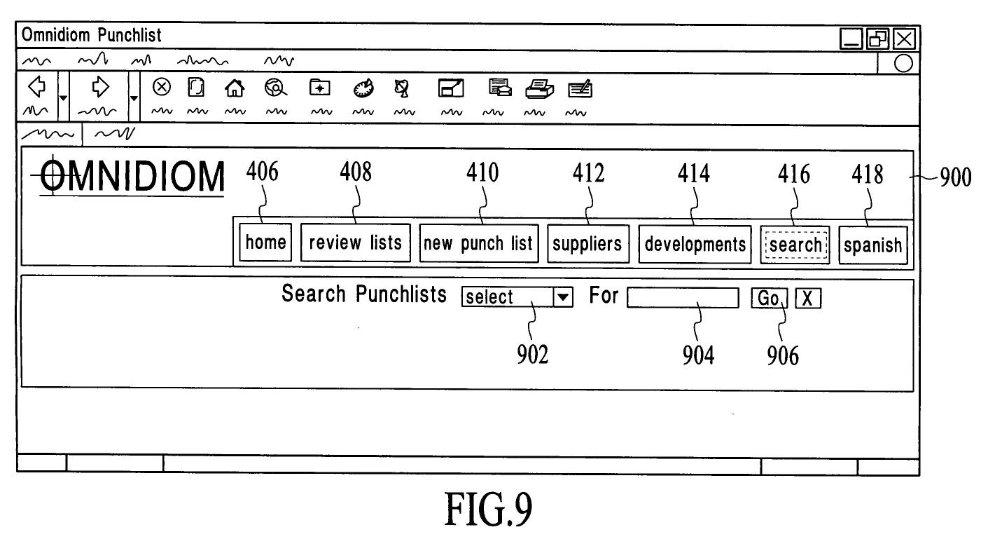

FIG. 9 is a screen shot of a search page 900 of a user interface of a management application, under an embodiment. The search page 900 provides an interface which allows a user to search for desired information after a user has clicked on the search button 416. As shown in FIG. 9, the search page 900 includes a search drop down menu 902, a search keyword window 904, and associated search button 906.

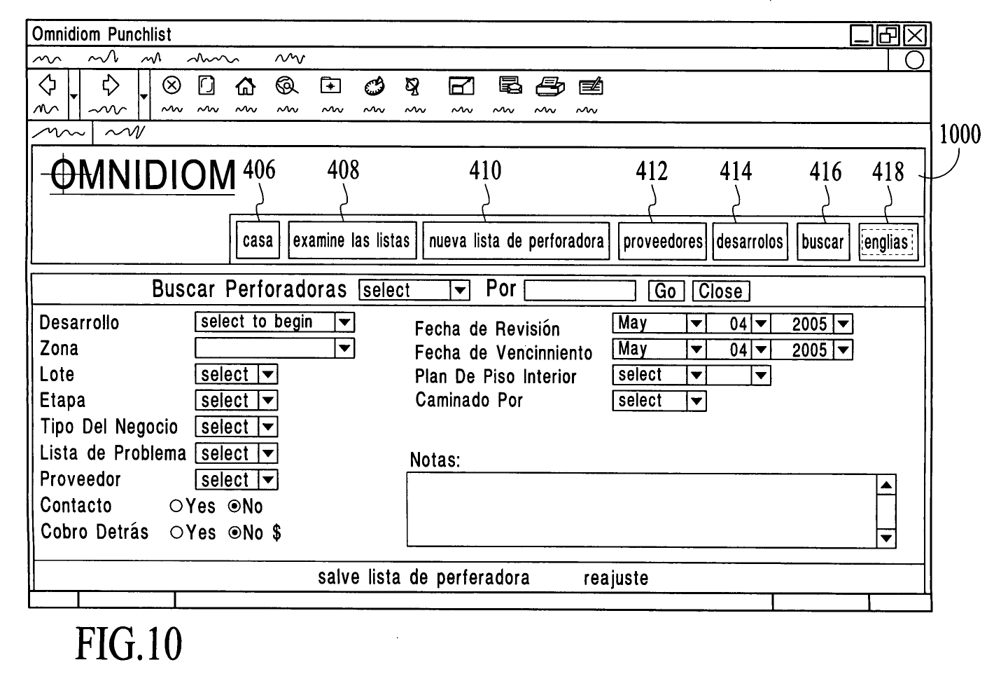

FIG. 10 is a screen shot of a Spanish translation of the create new punchlist screen of FIG. 6 after a user has clicked on the spanish button 418. As shown in FIG. 10, the page 1000 includes the same information as shown in FIG. 6 but presented in Spanish.

While FIGS. 3-10 are directed to a developer/supplier relationship, it is understood that the management system and application can be tailored to a desired implementation. For example, the various drop-down menus and fields are customizable to each business as well as to each product. Some example scenarios of using the management system 102 are provided below. Other embodiments are available.

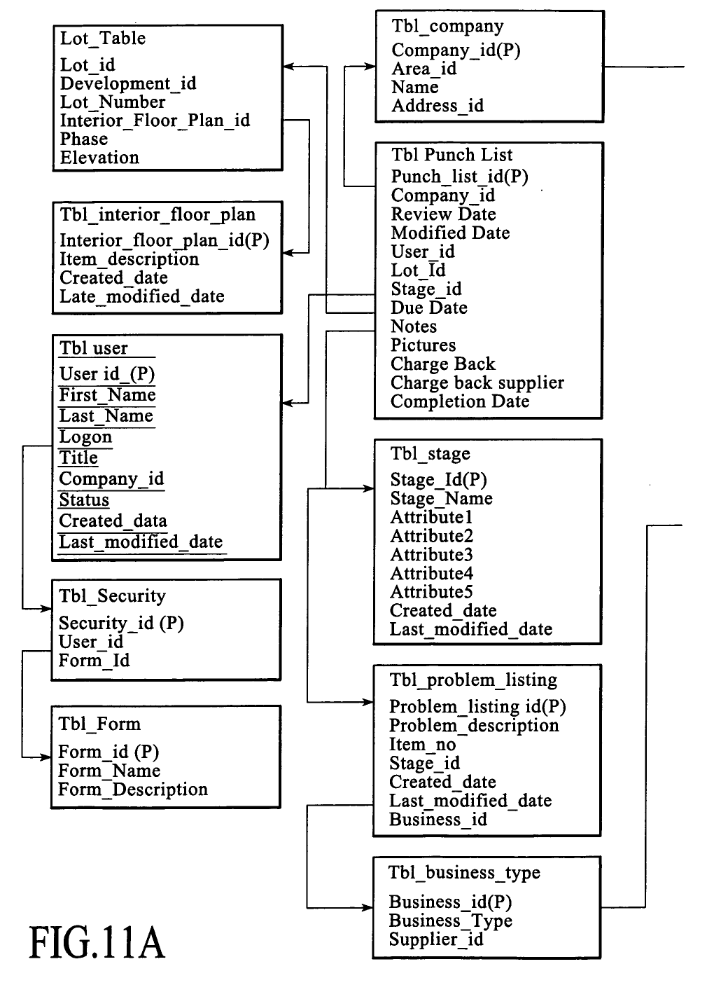

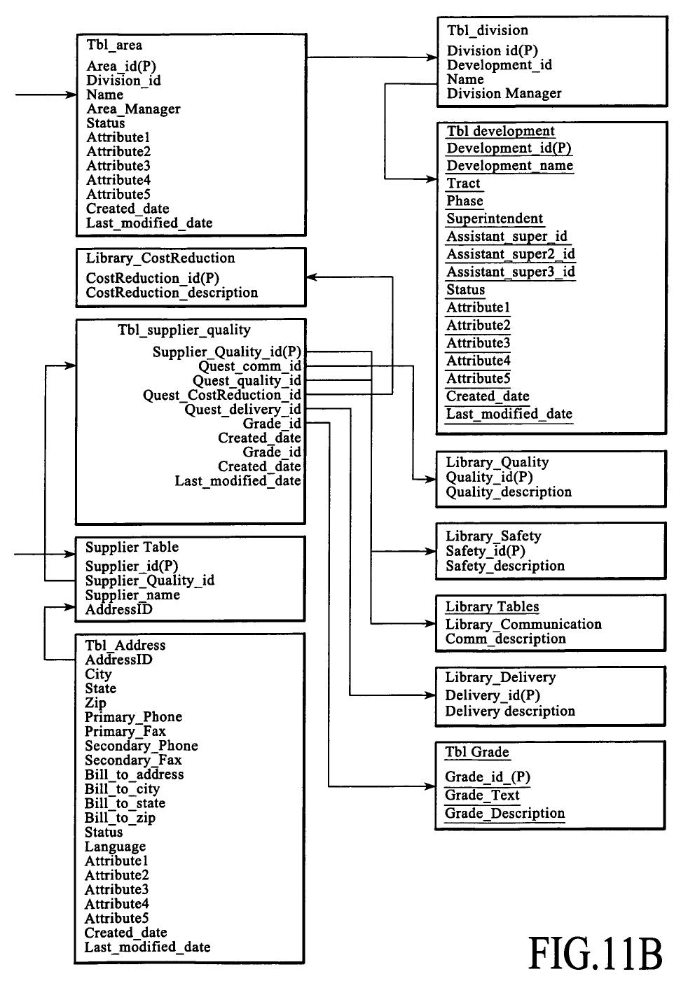

FIG. 11 is a block diagram depicting the interrelation between various tables and libraries of a management application directed to a build or development process, under an embodiment. FIG. 11 may also be described as an Entity Relationship Diagram. In various embodiments, the management system 102 is configured so that data associated with one entity can be logically separated from other entities but contained in the same infrastructure. The management system 102 is configured to recognize a user and direct that user to their database or databases, regardless of the device used to access the management system 102.

Scenario 1—Construction Industry—Tract Home Development:

CME Builders is building 20 new homes at CME Shores. Framing has just been completed on 3 of the homes and the Superintendent is reviewing the construction. The Superintendent notices that Lot 35 (one of the three framed homes) has a wall that is not plumb and needs to be fixed by the Framers. The Superintendent pulls out a smart device and logs into the management system 102. The login credentials indicate which development(s) they have access to. The Superintendent then selects the CME Shores development, and the concerned Lot along with other information such as review date and due date. The Superintendent then selects the problem from a list or enters a new item. The punchlist item is saved and the Superintendent continues to review the house. If additional items need repair, the Superintendent can select Duplicate punchlist and the Development/Lot and other information is kept allowing the entering of a new problem for that particular Lot.

Once the review is complete, the Superintendent can go back to the construction trailer and Log into the management system 102 to view the new items for the supplier in real-time. The Superintendent may then print out the items needing repairs and faxing to the framing supplier or at the end of the day a batch process runs and sends emails to each supplier automatically who has new items to be fixed. Once the repairs are completed, the Superintendent can review the repair and close out the item using the smart device or other processor-based device. Later, the Superintendent or CME management can review all problems with each Development, Lot by Problem type, Supplier or any combination of thereof in real-time using the management system 102.

Additionally, once an action from an action List has been accepted and marked completed, a supplier has the ability to invoice the customer directly for the completed action. At certain times, such as nightly, the system can batch all of the actions available for invoicing and provide the supplier with an invoice per customer detailing the development, lot and action completed with an applicable price for example. Once the supplier has reviewed the invoice, the Invoice is submitted via an e-mail or other notification, letting a customer know of the invoice.

Scenario 2—Apartment Complex—Large Apartment Complex Owners:

AME Partners owns several large apartment complexes. At Apartment complex A, the renter in apartment 23 is moving out. So the apartment manager meets with the leaving renter and notices one of the walls was damaged when the washing machine was removed. The manager uses a smart device and logs into the management system 102, selecting the apartment complex and rental unit. The manager then selects the appropriate problem and saves. At night, a batch process runs and notifies the appropriate supplier that a repair needs to be made at Rental unit number 23 at Apartment Complex A. The Apartment manager as well as the AME Partners management can review all items fixed at that Apartment, Unit, Problem type or Supplier directly, in real-time, using the management system 102.

Scenario 3—Warranty:

Bob and Debbie just bought a home and purchased a 1-year home warranty protection service for the home. The company providing the service uses the management system 102 for its warranty product. As part of the service, the company issued a URL (such as an Internet address), user name, password, and/or company code to Bob and Debbie should any issues/problems covered under the warranty arise. Three months later, a heavy winter rain came pounding down and to their dismay, a roof leak became apparent.

Bob and Debbie referred to the warranty documents and entered the proper URL in their laptop browser. At the login web page, they entered their user name, password, company code, and hit the enter key. The management system 102 authenticated the credentials and automatically provided their home address and details about how to get in touch with Bob and Debbie. The management system 102 then led Bob and Debbie step by step to enter where the leak was located. When they finished and saved the issue, the company responsible for the warranty was notified by the management system 102 in real-time and/or via e-mail. They in turn validated the warranty item. The warranty company then entered the same data and submitted it to their repair company who came out and repaired the leak. Bob and Debbie had to enter the data once and it was available until the leak was fixed. Thus, with only a few keystrokes, Bob and Debbie were able to efficiently and conveniently address the situation to their satisfaction.

Scenario 4—Inspection:

Jim works as an inspector for the City of Taboogle. Until recently, he had to write down all the violations he found for a particular inspection and then submit those to a city clerk who then input the data into a database. The inspection was then printed out and manually filed. Unfortunately, many times items were not filed correctly or the clerk was not able to enter the data in a timely fashion which caused Jim great anguish.

The City of Taboogle decided to use management system 102 which eliminated the need to re-enter the data. Moreover, all inspection data can be stored electronically for immediate retrieval wirelessly through Jim's Smart Phone. After receiving his login information and credentials, Jim was called to a job site to review the framing of a particular house. Once at the site, Jim used his smart phone to login to the management system 102 and selected the particular Builder, as described above. Based on the login information and credentials, the management system 102 provided Jim with only the Developments associated with the Builder.

Jim then used the interface, such as that shown in FIG. 6 to select the appropriate Development. In addition, based on the input so far, the management system 102 automatically determines associated lots and the lot numbers narrowing down 600 homes to just 20. He then selected the appropriate lot and completed his inspection. If the inspection was perfect, he signed off on the inspection and the Builder would have real-time access to verify the success of the inspection. If Jim had found anything wrong he could have entered the problem using his smart phone to interact with the management system 102. The Builder would then have real-time access to assess the problem. In addition, an email may be sent at a desired time, such as in the evening, letting the Builder know of the success or failure of the inspection. Moreover, the Builder can login and ascertain all inspections for each lot and determine which ones have been approved and which have not.

Jim was called out to another development with a different builder the same day. Unfortunately, the development was out of cellular range for Jim so he was not able to access a desired network, such as the internet, with his smart phone. Fortunately for Jim the builder installed WiFi at the development. So Jim pulled out his laptop (his smart phone was WiFi capable as well) and proceeded to complete the Inspection for the builder; letting the builder know in real-time the success or failure of the inspection.

The above scenarios provide real-world examples of the use of the management system 102. For certain embodiments, all that is required is a network connection or available network and a network-capable device. Any number of devices are recognized by the management system 102, including smart devices, WiFi-enabled products, laptops, desktops, and other devices operable to connect to a network, such as the Internet. Once the data has been entered by a first entity, a second entity or other entity has real-time access to any item/issue submitted by the first entity.

The above description demonstrates the powerful capability of the management system to maintain to-do lists and the like, in a timely, efficient, and trustworthy manner. The management system can be applied to generic punchlist design and implementation, generic scheduling design and implementation, generic auto-invoice design and implementation, to-do list design and implementation, and many other applications. The management system can be tailored to the specifications of the end users and does not require users to buy additional hardware or software with the exception of a device operable to connect to a network. The management system does not require syncing between a user device and allows real-time access to data from the field any where and anytime.

Aspects of the invention may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the invention include: microcontrollers with memory (such as electronically erasable programmable read only memory (EEPROM)), embedded microprocessors, firmware, software, etc. Furthermore, aspects of the invention may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The functions described herein as the invention can be performed by programs or sets of program codes, including software, firmware, executable code or instructions running on or otherwise being executed by one or more general-purpose computers or processor-based systems. The computers or other processor-based systems may include one or more central processing units for executing program code, volatile memory, such as RAM for temporarily storing data and data structures during program execution, non-volatile memory, such as a hard disc drive or optical drive, for storing programs and data, including databases and other data stores, and a network interface for accessing an intranet and/or the Internet. However, the functions described herein may also be implemented using special purpose computers, wireless computers, state machines, and/or hardwired electronic circuits.

It should be noted that components of the various systems and methods disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages.

Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, and/or wired signaling media. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other systems, not only for the systems described above. The elements and acts of the various embodiments described above can be combined to provide further embodiments. These and other changes can be made to the invention in light of the above detailed description.

All of the above references and United States patents and patent applications are incorporated herein by reference. Aspects of the invention can be modified, if necessary, to employ the systems, functions and concepts of the various patents and applications described above to provide yet further embodiments of the invention.

In general, in the following claims, the terms used should not be construed to limit the invention to the specific embodiments disclosed in the specification and the claims, but should be construed to include all systems that operate under the claims. Accordingly, the invention is not limited by the disclosure, but instead the scope of the invention is to be determined entirely by the claims.

While certain aspects of the invention are presented below in certain claim forms, the inventor contemplates the various aspects of the invention in any number of claim forms. For example, while only one aspect of the invention is recited as embodied in computer-readable medium, other aspects may likewise be embodied in computer-readable medium. Accordingly, the inventor reserves the right to add additional claims after filing the application to pursue such additional claim forms for other aspects of the invention.

What is claimed is:

1. A system for managing information associated with one or more tasks comprising:
a database component to maintain data associated with the one or more tasks;
an application component including an application configured to enable a first entity to interact and communicate an issue associated with a task, wherein the issue is stored in the database component and is available to a second entity in real-time, wherein the second entity can perform an action to resolve the issue and interact with the application component to inform the first entity that the issue associated with the task is resolved; and
a network interface to enable communication to the database component and application component.

2. The system of claim 1, further comprising:
at least one processor-based device for interacting with the application component to manage a task, wherein the at least one processor-based device is selected from among personal computers, portable computing devices, smart devices, cellular telephones, portable communication devices, and personal digital assistants; and
a device interface to enable the at least one processor-based device to communicate with the database component and the application component.

3. The system of claim 1, wherein the application component is a network-based application provided by an application service provider.

4. The system of claim 1, wherein the application is to enable a first entity to interact and communicate an item associated with a to-do list to a second entity, wherein the item is available to a second entity in real-time and the second entity can perform an action to resolve the item associated with the to-do list.

5. The system of claim 1, wherein the application is to communicate a custom interface to the first entity based in part on login credentials provided by the first entity when interacting with the application.

6. The system of claim 2 further configured to recognize a device type once the at least one processor-based device has communicated with the system.

7. The system of claim 1 further configured to communicate an automated communication to the second entity after the first entity has communicated the issue to the database component.

8. The system of claim 1, further comprising an automated invoicing functionality for providing an invoice to the first entity after resolving the issue.

9. The system of claim 1, wherein the application component and database component comprise separate servers.

10. A method for managing an outstanding issue associated with a task, the method comprising:
identifying the outstanding issue associated with the task;
receiving login credentials;
authenticating the login credentials;
interacting with an application component after authenticating the login credentials, wherein an amount of interaction and information presented by the application component is based in part on the login credentials;
communicating the outstanding issue associated with the task to the application component;
storing the outstanding issue to a database component; and, communicating the outstanding issue so that appropriate action can resolve the outstanding issue.

11. The method of claim 10, further comprising interacting with the application component to post information showing that the task is resolved.

12. The method of claim 11, further comprising interacting with the application component to verify that the outstanding issue is resolved.

13. The method of claim 12, further comprising interacting with the application component to close-out the outstanding issue.

14. The method of claim 10, wherein the interacting further comprises using at least one processor-based device to interact with the application component to manage a task, wherein the at least one processor-based device is selected from among personal computers, portable computing devices, smart devices, cellular telephones, portable communication devices, and personal digital assistants.

15. The method of claim 14, further comprising recognizing a device type once the at least one processor-based device has interacted with a device interface associated with the application component.

16. The method of claim 10, wherein the communicating the outstanding issue further comprises communicating an automated alert after the outstanding issue has been stored in the database component.

17. The method of claim 10, further comprising issuing an invoice after resolving the outstanding issue.

18. A computer readable medium including executable instructions which, when executed in a system, manage an outstanding item associated with a to-do list by receiving login credentials;
authenticating the login credentials;
interacting with an application component after authenticating the login credentials, wherein an amount of interaction and information presented by the application component is based in part on the login credentials;
communicating the outstanding item associated with the to-do list to the application component;
storing the outstanding item to a database component; and,
communicating the outstanding item to resolve the outstanding item.

19. The computer-readable medium of claim 18, wherein the instruction when executed, further manage an outstanding item associated with a to-do list by communicating an automated alert after the outstanding item has been stored in the database component.

20. The computer-readable medium of claim 18, wherein the instruction when executed, further manage an outstanding item associated with a to-do list by issuing an invoice after resolving the outstanding item.
